(19) United States
(12) Patent Application Publication
(10) Pub. No.: US 2021/0392832 A1
(43) Pub. Date: Dec. 23, 2021

(54) Apparatus, System and Method for Watering Plants

(71) Applicant: CUBICFARM SYSTEMS CORP., Langley (CA)

(72) Inventor: Leo BENNE, Langley (CA)

(21) Appl. No.: 17/289,485

(22) PCT Filed: Oct. 9, 2019
(86) PCT No.: PCT/CA2019/000141

§ 371 Date: Apr. 28, 2021

Related U.S. Application Data
(60) Provisional application No. 62/753,425, filed on Oct. 31, 2018.

(51) Int. Cl. A01G 31/04; A01G 31/06; A01G 27/00; A01G 7/06

(52) U.S. Cl. CPC A01G 31/042; A01G 31/06; A01G 7/06; A01G 27/003; A01G 27/008

(57) ABSTRACT

A plant watering apparatus comprising: a watering trough, for receiving and holding a growth-sustaining liquid therein; an actuator for actuating the watering trough between a first position and a second position; and a carrier system comprising a pair of conveyors and a plurality of cradles, the cradles supported by the pair of conveyors and spaced apart therealong, the cradles holding supported plants therein. The conveyors convey the cradles along a path, thereby transporting the cradles to and from a watering position disposed above the watering trough. When a cradle is at the watering position, the watering trough can be elevated to the second position, thus immersing the supported plants in the growth-sustaining liquid in the watering trough so as to permit uptake of the growth-sustaining liquid by the supported plants.

### FIELD OF THE INVENTION

The present invention relates to the field of horticultural watering systems. More specifically, the present invention relates to an apparatus, system and method for watering plants within a carrier system using an actuating watering trough.

### BACKGROUND

Traditional commercial farming techniques typically require large amounts of viable land to cultivate, grow and harvest a crop, and are typically very time and labor-intensive. More recent innovations in the field include so-called vertical farming systems, in which plants are grown in stacked layers, thus potentially drastically cutting down on such farm's footprint and land requirements. Furthermore, many modern vertical farming systems employ indoor farming or hydroponic techniques, wherein environmental conditions (such as water/irrigation, light, temperature, humidity, carbon dioxide, etc.) and other growing conditions (such as fertilizer use, pesticide use, etc.) may be more carefully controlled and/or monitored. In some cases, such indoor vertical fanning techniques also utilize automated and/or mechanical systems to move and distribute the stacked layers of plants in order to either facilitate the processing (e.g. irrigation, treatment, harvesting, etc.) of said plants and/or to adjust each plant's exposure to growing conditions (light, air, humidity, temperatures, etc.), as appropriate.

By way of example, PCT/CA2012/050281 (Publication No. WO2012151691), incorporated by reference herein, discloses a growing machine (and a corresponding method) for growing plants by advancing a plurality of plant cradles on an endless conveyor along an undulating growing path having alternating upward and downward portions and having a return portion for looping back thereto. Using a pair of parallel endless conveyors, the cradles are removably supported between the conveyors. The cradles are supplied with growth-sustaining liquid and growth-promoting light. The cradles are advanced along the path until the one or more plants have reached a target growth after which they can be harvested or transferred to one or more subsequent machines until mature for harvest. The machine can be in a controlled environment.

Canadian Patent No. 1,106,607 discloses an apparatus for the continuous growing of plants in an enclosed growing room, wherein a meandering conveyor carrying plants in a grid pattern moves the plants past lamps, in a serpentine pattern. The lamps are arranged in a grid pattern and have a spatial light distribution curve which matches the spatial path curve of the conveyor so that the illumination near the plants is substantially constant.

Within the field of hydroponics, known watering systems include floating ponds, flood and drain systems and nutrient film techniques. In the mechanical plant growing systems mentioned above, after a growth-sustaining liquid (typically consisting of water and, if applicable, a nutrient mix) is applied to the plants, such growth-sustaining liquid is then typically carried around in the growing trays or cradles holding the plants.

As described herein, it is contemplated that the watering apparatus, system and method of the present invention can provide a number of advantages.

### SUMMARY OF THE INVENTION

In accordance with an aspect of the present invention, disclosed herein is an apparatus, system and method for watering plants, wherein such plants are being grown in a plurality of cradles supported by a conveyor. A watering trough is mounted on or supported by a lifting mechanism in the form of one or more actuators. The watering trough is provided to receive and hold a growth-sustaining liquid. The watering trough is actuable between a lower first position and an elevated second position, through operation of one or more actuators. When one of the cradles supporting one or more supported plants therein, is conveyed to a watering position disposed above the watering trough, and the watering trough is actuated to the second position, this wholly or partially immerses the one or more supported plants in the growth-sustaining liquid, thus providing the plants with desired irrigation. When the watering trough is actuated to the first position, the one or more supported plants is removed from the growth-sustaining liquid. This watering is repeated for each successive cradles (and the supported plants therein), in what may be a continuous process.

In one embodiment, an apparatus for watering plants is provided comprising: (i) a watering trough, for receiving and holding a growth-sustaining liquid therein; (ii) an actuator means configured to actuate the watering trough between a first position and a second position; and (iii) a carrier system comprising a pair of conveyors and a plurality of cradles, the plurality of cradles supported by the pair of conveyors and spaced apart therealong, each cradle supporting one or more supported plants therein; wherein the pair of conveyors are configured to convey the plurality of cradles along a path, thereby transporting each one of the plurality of cradles to and from a watering position, wherein when said one of the plurality of cradles is at the watering position and the watering trough is in the second position, said one or more supported plants is at least partially immersed in the growth-sustaining liquid in the watering trough so as to permit uptake of the growth-sustaining liquid by the one or more supported plants, and when said one of the plurality of cradles is at the watering position and the watering trough is in the first position, said one of the plurality of cradles is removed from the growth-sustaining liquid in the watering trough.

In another embodiment, an apparatus for watering plants is provided comprising: (i) a watering trough, for receiving and holding a growth-sustaining liquid therein; (ii) an actuator configured to actuate the watering trough between a first position and a second position; and (iii) a carrier system comprising a pair of parallel conveyors and a plurality of cradles, the plurality of cradles supported by the pair of conveyors and spaced apart therealong, each cradle supporting one or more growing trays, said one or more growing trays adapted to support one or more supported plants therein; wherein the pair of conveyors are configured to convey the plurality of cradles along a path, thereby transporting each one of the plurality of cradles to and from a watering position, wherein when said one of the plurality of cradles is at the watering position and the watering trough is in the second position, said one or more supported plants is at least partially immersed in the growth-sustaining liquid in the watering trough so as to permit uptake of the growth-sustaining liquid by the one or more supported plants, and when said one of the plurality of cradles is at the watering position and the watering trough is in the first position, said one or more supported plants is removed from the growth-sustaining liquid in the watering trough.

In another embodiment, an apparatus for watering plants is provided comprising: (i) a watering trough, for receiving and holding a growth-sustaining liquid therein; (ii) an actuator configured to actuate the watering trough between an access position and a dunking position; and (iii) a carrier system comprising a pair of parallel conveyors and a plurality of cradles, the plurality of cradles supported by the pair of conveyors and spaced apart therealong, each cradle supporting one or more growing trays, said one or more growing trays adapted to support one or more supported plants therein; wherein the pair of conveyors are configured to convey the plurality of cradles along a path, thereby transporting each one of the plurality of cradles to and from a watering position, wherein when said one of the plurality of cradles is at the watering position and the watering trough is in the dunking position, the one or more supported plants in said one of the plurality of cradles is at least partially immersed in the growth-sustaining liquid in the watering trough so as to permit uptake of the growth-sustaining liquid by the one or more supported plants, and when the watering trough is in the access position, the said one of the plurality of cradles may be conveyed by the conveyor away from the watering position and a successive one of the plurality of cradles may be conveyed by the conveyor to the watering position.

In one aspect, the pair of conveyors is an endless conveyor, and the path is a continuous loop. In another aspect, the growing trays may be provided with one or more openings to allow growth-sustaining liquid to flow into the growing trays when the growing trays are wholly or partially immersed into the watering trough. In one aspect, the supported plants are seeds or seedlings.

In one aspect, the second position is elevated above the first position. In another aspect, the second position is disposed substantially vertically above the first position.

In one aspect, each one of the plurality of cradles, when in the watering position, is disposed substantially above the watering trough.

In one aspect the carrier system is additionally provided with a motor for mechanically driving the conveyor, thereby conveying the cradles along the path. In another aspect, the carrier system may be manually-driven.

In one aspect, the actuator means is an actuator. In another aspect the actuator comprises one or more pneumatically or hydraulically-driven mechanisms.

In one aspect, the types of supported plants may be selected from the group consisting of lettuces, leafy greens, cucumbers, peppers, tomatoes, cucumbers, herbs and flowers, and also long vine plants, trees, etc. In another aspect, the supported plants being grown on the watering apparatus or in a particular growing tray may be of different types. In another aspect, the supported plants may be at varying stages of growth.

In another embodiment, disclosed herein is a method of watering plants comprising: the steps of: (i) providing a watering apparatus described above; (ii) operating the pair of conveyors to convey a cradle to the watering position; (iii) filling the watering trough with growth-sustaining liquid; (iv) activating the actuators to actuate the watering trough from the first position to the second position, thereby immersing the supported plants in the growth-sustaining liquid; deactivating the actuators to return the watering trough from the second position to the first position; operating the pair of conveyors to convey the cradle away from the watering position and to convey a successive cradle to the watering position; and repeating the cycle from step (iii).

In another embodiment, a plant growing system is disclosed comprising the disclosed apparatus for watering plants combined with a machine for growing plants along an undulating path.

### BRIEF DESCRIPTION OF THE DRAWINGS

Embodiments of the present invention are described below with reference to the accompanying drawings in which:

FIG. 1 is an isometric view of a diagrammatic representation of a portion of the watering apparatus in accordance with an aspect of the present invention, wherein the watering trough is in a first position.

FIG. 2 is an isometric view of a diagrammatic representation of a portion of the watering apparatus in accordance with an aspect of the present invention, wherein the watering trough is in a second position.

FIG. 3 illustrates a sectional isometric view of the watering trough immersing an array of plant/seedling trays in the growth-sustaining liquid that is contained in the watering trough.

FIG. 4 is an isometric view of a diagrammatic representation of the watering trough in accordance with an aspect of the present invention, with the watering trough shown in a first position.

FIG. 5 is an isometric view of a diagrammatic representation of the watering trough in accordance with an aspect of the present invention, with the watering trough shown in a second position.

FIG. 6 is a sectional isometric view of a portion of the watering trough in accordance with an aspect of the present invention.

FIG. 7 is an isometric view of one end of the watering trough in accordance with an aspect of the present invention.

FIG. 8 is an isometric diagrammatic representation of an exemplary cradle in accordance with an aspect of the present invention.

FIG. 9 is an isometric diagrammatic representation of an exemplary cradle, shown loaded with an array of plant trays, in accordance with an aspect of the present invention.

FIG. 10 is an enlarged view of one side of an exemplary cradle loaded with an array of plant trays.

FIG. 11 is a perspective view of another exemplary embodiment of the watering trough, in accordance with an aspect of the present invention.

FIG. 12 is a front side view of the exemplary embodiment of the watering trough shown in FIG. 11.

FIG. 13 is a top plan view of the exemplary embodiment of the watering trough shown in FIG. 11.

FIG. 14 is an end view of the exemplary embodiment of the watering trough shown in FIG. 11.

FIG. 15 is a front view of one side of an exemplary embodiment of the watering apparatus in accordance with an aspect of the present invention.

FIG. 16 is a front perspective view of an exemplary embodiment of the watering apparatus, with the watering trough in a first position, in accordance with an aspect of the present invention.

FIG. 17 is a front perspective view of an exemplary embodiment of the watering apparatus, with the watering trough in a second position, in accordance with an aspect of the present invention.

### DETAILED DESCRIPTION OF THE INVENTION

The present invention now will be described more fully hereinafter with reference to the accompanying drawing(s), which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense. Unless defined otherwise, all technical and scientific terms used herein have the same meaning as commonly understood by one of ordinary skill in the relevant art.

Except as otherwise expressly provided, the following rules of interpretation apply to this specification (written description, claims and drawings): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “herein before”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

To the extent necessary to provide descriptive support, the subject matter and/or text of the appended claims is incorporated herein by reference in their entirety.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize, or be able to ascertain using no more than routine experimentation, many equivalents to the specific example embodiments specifically described herein. Such equivalents are intended to be encompassed in the scope of the claims, if appended hereto or subsequently filed. It should be understood that any methods or materials that are similar or equivalent to those methods or materials that are specifically described herein, may also be used in respect of the present invention.

The present invention will primarily be illustrated and discussed herein in the context of a hydroponic plant growing system. However, it should be understood that the present invention could also be applied in a non-hydroponic or soil-based plant growing system.

The present invention is sometimes depicted herein for use in growing/watering leafy greens, for illustrative purposes. However, it is contemplated that the present invention may be used for virtually any types of plants, including any plants which are known to be suitable for cultivation using hydroponic systems.

It is contemplated that the present invention can be suitably applied particularly for germination of seedlings, and is sometimes illustrated and discussed herein in the context of such. (One reason the invention is particularly well suited to being used with seeds/seedlings is because seeds/seedlings generally require only a small growing space, which generally means that a larger number of seeds/seedlings may be supported in each cradle and watered with each dunking, for a particular size of watering apparatus). However, it is to be understood that the present invention is not restricted to such application, but may be applied as a general automated watering apparatus for any plant growing purposes. It can be also be applied to general plant propagation purposes, which can encompass numerous other commercially-grown types of plants, including, for example, tree seedlings, peppers, tomatoes, cucumbers, herbs, flowers, long vine plants, and any other food, flower and ornamental plants, etc.

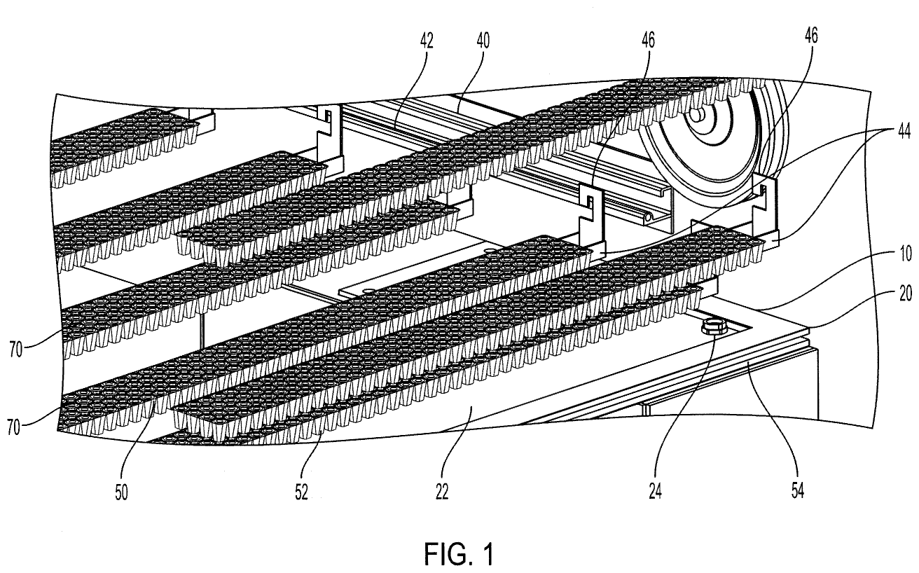

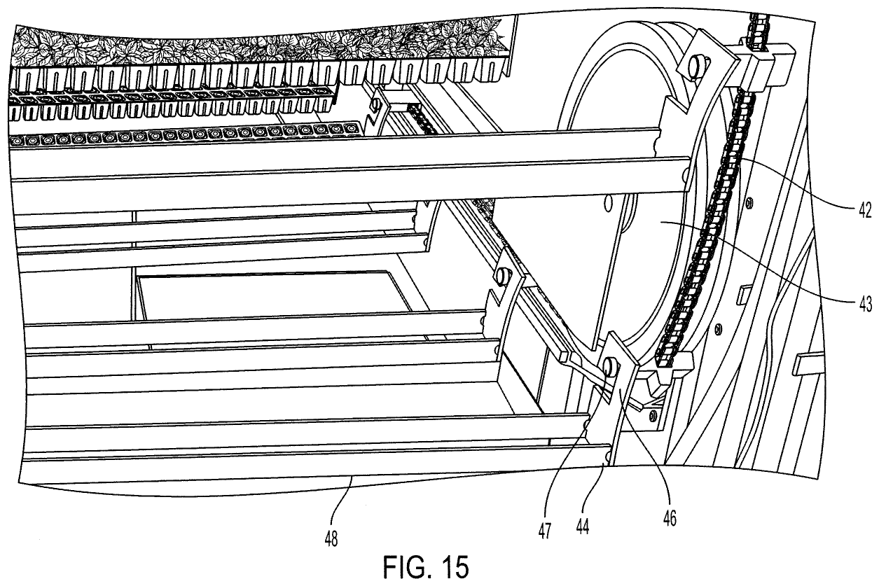

Referring to FIG. 1, this illustrates an isometric view of a portion of the watering apparatus 10 in accordance with an aspect of the present invention, wherein the watering trough 20 is shown in a lower first position 54. A carrier system 40 is shown, comprising a pair of parallel conveyors 42 and a plurality of elongate cradles 44 therebetween. The cradles are spaced apart along the pair of conveyors 42. (The suitable spacing between adjacent cradles may be adjusted depending on various factors, such as the size of the plants being grown, the size of the growing trays being used, etc.). For ease of reference, the carrier system 40 is depicted with one of the pair of parallel conveyors removed from view—i.e. only one of the pair of conveyors 42 is shown. The cradles 44 are shown as being provided with a securing means, located proximate to each end of each cradle 44, by means of which each cradle is supported on the conveyor 42. In the embodiment of FIG. 1, the securing means is shown in the form of a cradle hanger 46. The cradle hanger 46 may, for example, be attached to the conveyor via a supporting pin 47 (as may be more clearly seen in FIG. 15) which is engaged with the conveyor 42. Other possible securing means will be understood to one skilled in the art, such as any fastener, clamp, hanger or support. Optionally, the securing means may be detachable from and attachable to the conveyor 42.

The carrier system 40 may be provided with a motor or drive (not shown) that operates, as and when required, to move the pair of conveyors 42, thereby conveying the plurality of cradles along a path. The pair of conveyors 42 can convey each of the plurality of cradles along the path to a watering position 52. The watering position 52 is the position along the path where a cradle supporting the plants can be “watered”. As shown in FIG. 1, when a cradle is at the watering position 52, it is disposed above the watering trough 20. The watering trough 20 can be provided with a growth-sustaining liquid 22. (As used herein, growth-sustaining liquid refers to the medium for nourishing the plants, which is typically water, optionally provided with any desired additives, such as a suitable nutrient or fertilizer mix). The watering trough 20 may be filled to the desired level with growth-sustaining liquid 22, from a reservoir (not specifically shown) between each “dunking”. Generally, growth-sustaining liquid is pumped from the reservoir to refill the watering trough. The reservoir pump may be synchronized with the rest of the watering apparatus (and/or provided with sensors) in order to maintain a fixed volume/height of growth-sustaining liquid in the watering trough 20.

In one embodiment, the path is an endless path (i.e. one which loops back upon itself). As shown, the path can be in the general shape of an oblong having semicircular ends. Other configurations for the path are of course possible, including, for example, oval, circular, oblong, triangular, etc. or combinations thereof. In one embodiment, the pair of conveyors 42 may be in the form of a chain and sprocket wheel 43 combination (as may be more clearly seen in FIG. 15).

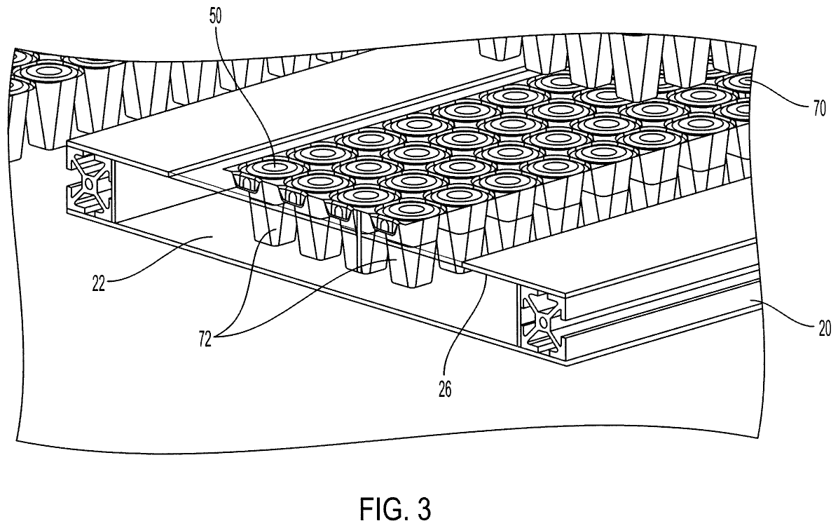

Each of the cradles 44 is shown as supporting a growing tray 70 (more clearly visible in FIG. 3). Each growing tray 70 may support or hold one or more supported plants 50. As used herein, supported plants 50 may be used to refer to any plants for which the watering apparatus 10 may be applied, and can include seeds that are yet to or about to germinate, germinating seedlings, grown seedlings, growing plants and relatively mature plants.

In accordance with one embodiment, each growing tray 70 can comprise a plurality of growing cups 72. In this case, it is the growing cups 72 that are used to hold or support one or more supported plants 50. The growing trays 70 are shown configured in an elongate array of growing cups 72. For example, a growing tray 70 may be 4 growing cups wide and say 40-100 growing cups long. Different arrays and sizes of growing cups are of course possible.

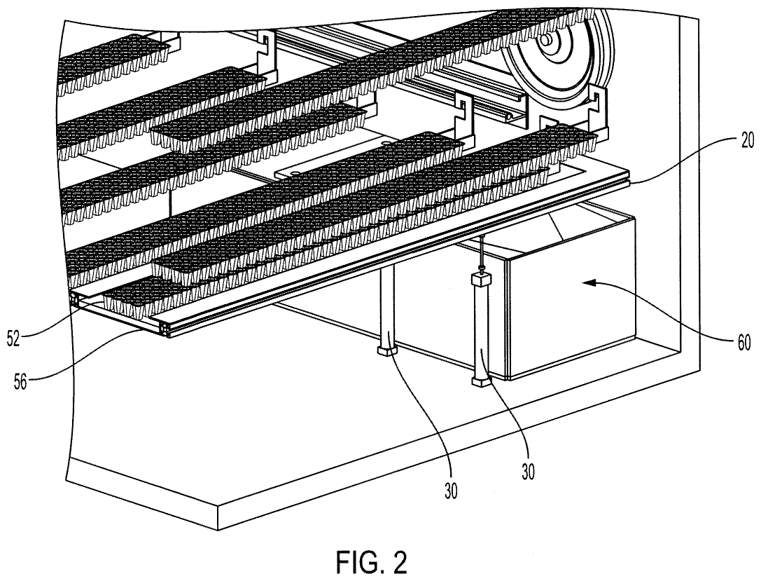

FIG. 2 is an isometric view illustrating a portion of the watering apparatus 10, wherein the watering trough 20 is in a second position 56. Again, the carrier system 40 is depicted with one of the pair of parallel conveyors removed for ease of reference. In one embodiment, the second position 56 is substantially vertically above the first position 54. The watering trough 20 is shown being supported by one or more actuator means, in the form of actuators 30. The actuators 30 operate to reversibly actuate the watering trough 20 between a first position and a second position. In one embodiment, the actuators 30 are fixed at their base to the floor/base underneath the watering trough 20. The upper end of each of the actuators is affixed to the watering trough 20. In a preferred embodiment, the actuators are hydraulically or pneumatically-powered and are extendable and collapsible. In a further preferred embodiment, the actuators are pneumatic air return cylinders, which are provided with regulators to actuate/energize evenly. When the actuators 30 are actuated or energized, they function to raise the watering trough 20 in a level fashion from a lower first position 54 to an elevated second position 56. It is contemplated that the actuator means may alternatively be in the form of a motor and screw assembly. As the watering trough 20 is raised, this causes a cradle 44 (with a growing tray 70) that is disposed above the watering trough and located at the watering position to be immersed or “dunked” in the growth-sustaining liquid contained within the watering trough 20. When the actuators 30 are non-actuated or de-energized, the watering trough is lowered back into the first position 54. This lowering of the watering trough 20 has the effect of removing the cradle 44 (and associated growing tray 70) that was being watered/dunked, to be removed from the growth-sustaining liquid in the watering trough 20. The watering apparatus 10 may also be provided with an irrigation box 60 for capturing/holding any growth-sustaining liquid that overflows from the watering trough 20. Such overflows may be recycled back to the reservoir or watering trough, if desired.

FIG. 3 illustrates a sectional isometric view of a portion of the watering trough 20. A growing tray 70, comprising an array of growing cups 72, each of the growing cups for supporting/holding one or more supported plants 50 therein, is shown being immersed in (or flooded by) the growth-sustaining liquid 22 in the watering trough 20 as the watering trough 20 is raised into the elevated second position 54. Generally, it is contemplated that a substantially elongate array of growing cups 72 is preferred, since this allows for a large number of plants to be “watered” at each single “dunking”, while maintaining the possible benefits of a small areal footprint associated with vertical stacking of the growing trays. The watering trough 20 may be in the form of any water-tight container which is open-to-above. In one exemplary embodiment, the watering trough may be oblong shaped. The watering trough 20 may optionally be provided with one or more protruding tabs 26, which are disposed around the periphery of the watering trough, and which function to help limit/prevent overflow and splashing out of the growth-sustaining liquid 22 over the edges of the watering trough 20 during the dunking procedure.

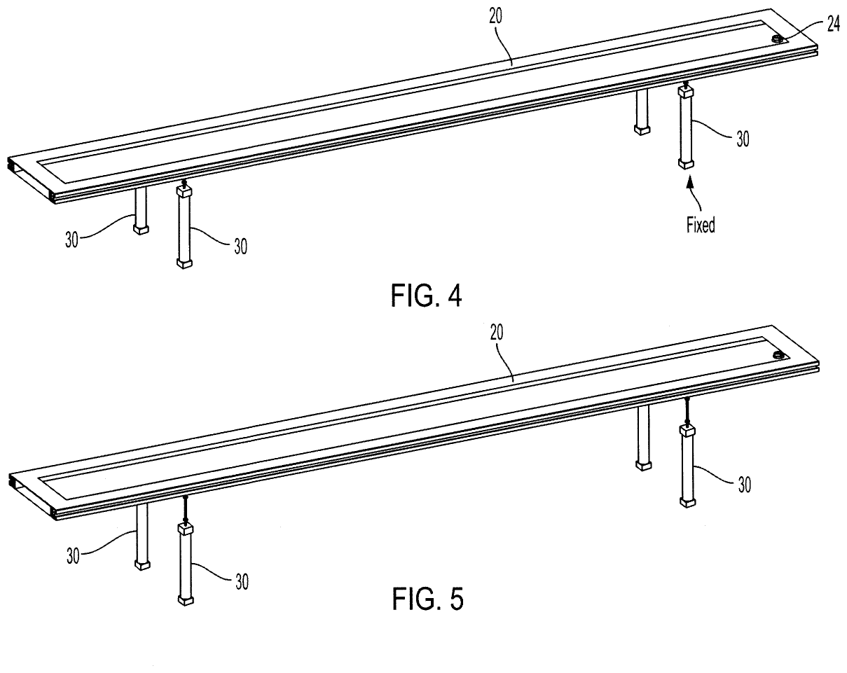

FIG. 4 is an isometric view illustrating the watering trough 20 in isolation. The watering trough 20 is shown in a lower first position 54 (where the actuators 30 are non-actuated or de-energized, and hence un-extended). FIG. 5 is an isometric view illustrating the watering trough in isolation, in an elevated second position 56 (where the actuators 30 are actuated or energized, and hence extended). In this fashion, the actuators 30 can cause the watering trough 20 to be raised and lowered between the first position and the second position. In addition, it is contemplated that various spring-type mechanisms as are known in the art (not shown) may also be utilised to facilitate the movement of the watering trough between positions (e.g. the return of the watering trough 20 from the second position back to the first position). Other configurations are possible for actuating the watering trough 20. For example, the actuation mechanism may be reconfigured such that actuation of the actuators 30 causes the watering trough to be lowered, and de-actuation causes the watering trough to be raised; alternatively the actuation mechanism may be reconfigured such that actuation causes the actuators to be collapsed and the watering trough lowered, while the non-actuation of the actuators 30 causes the actuators to be extended and the watering trough to be raised.

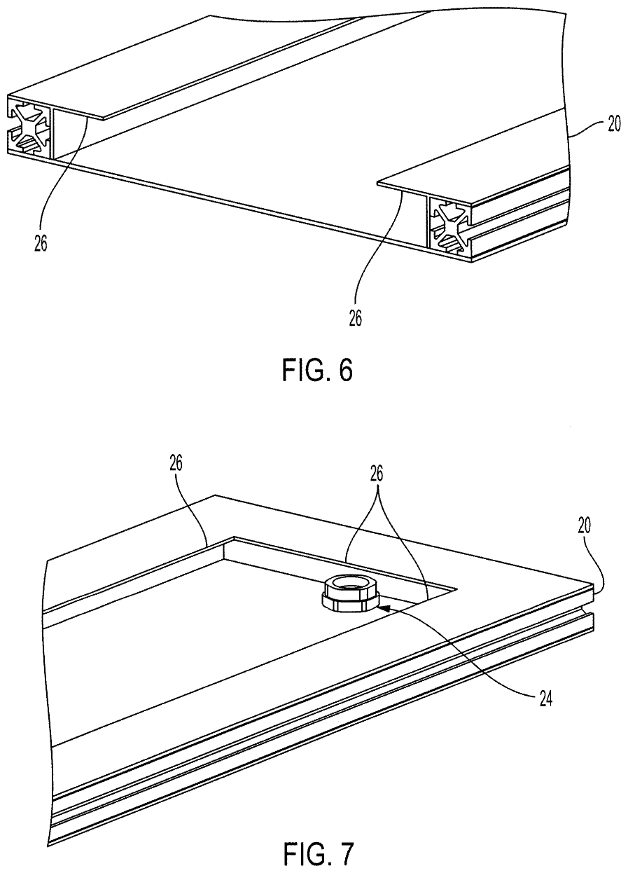

FIG. 6 is another sectional view of a portion of the watering trough. As previously described, the watering trough 20 may be provided with one or more protruding tabs 26, which are disposed around the periphery of the watering trough to help prevent overflow and splashing out of the growth-sustaining liquid 22 during the dunking procedure.

FIG. 7 is an isometric view of one end of the watering trough 20. The watering trough 20 may be provided with one or more overflow outlets 24. The overflow outlet serves to prevent the watering trough 20 from overfilling, and also allows for excess growth-sustaining liquid to be released from the watering trough during the dunking procedure. The overflow outlet 24 may simply take the form of a raised nut as shown positioned at an outlet opening, the top of which nut is at a suitable height to provide for the desired level of growth-sustaining liquid in the watering trough. The height of the top of the raised nut may or may not by adjustable. Any overflows can pass from the overflow outlet 24 to an irrigation box 60.

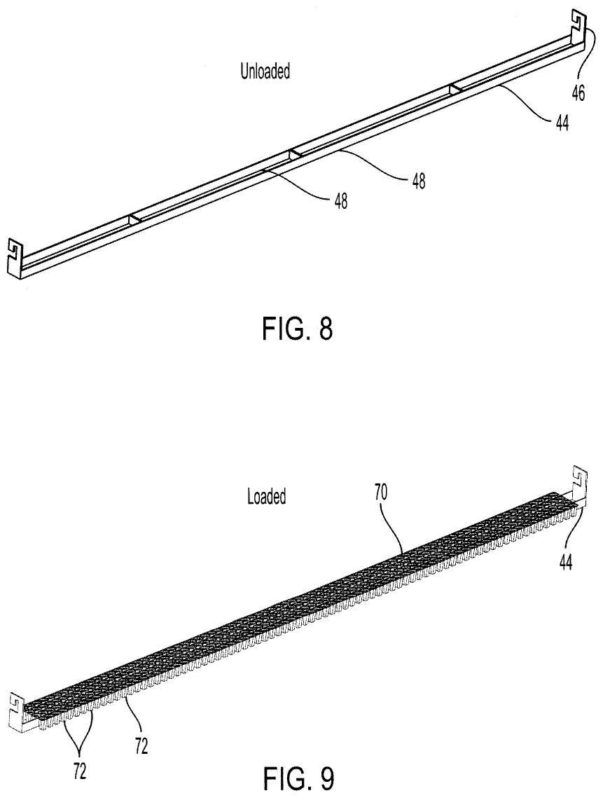

FIG. 8 is an isometric diagrammatic representation of an exemplary cradle 44. The cradle is provided with a securing means, which as specifically illustrated is a set of cradle hangers 46 generally located at or near both ends of the cradle 44. The cradle hangers 46 function to attach to the pair of conveyors 42, such that the cradle is supported by said pair of conveyors 42. In one embodiment, the cradle 44 comprises one or more rib frames 48 or spines (sometimes also referred to as a spine-style cradle), which span the length of the cradle 46. The rib frame 48 and the cradle 44 are adapted to support a growing tray 70, which comprises an array of growing cups 72. FIG. 9 illustrates an exemplary cradle 44, shown loaded with a growing tray 70 having a plurality of growing cups 72.

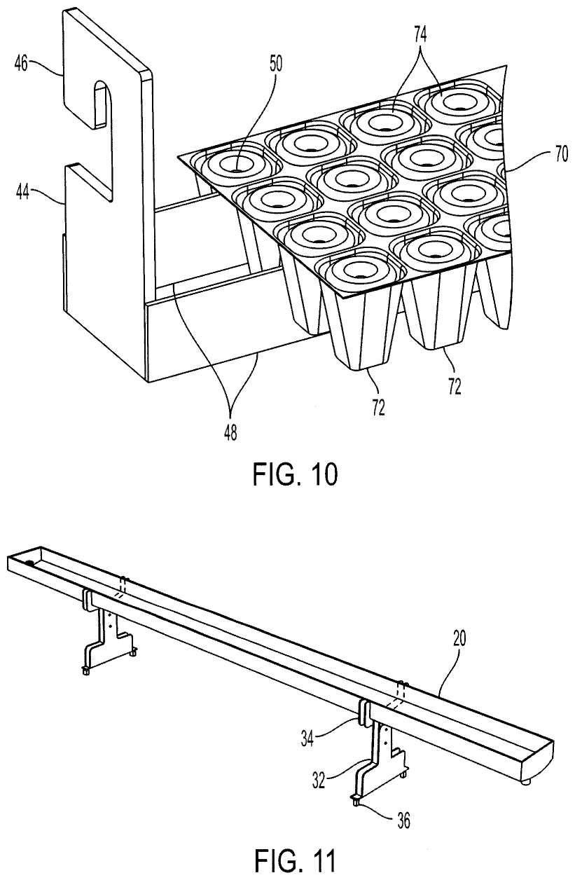

FIG. 10 is an enlarged view of one side of an exemplary cradle 44 loaded with a growing tray 70 of growing cups 72. In the embodiment shown, each of the growing cups 72 may be adapted to receive a plug 74 therein. The plug 74 serves to contain and support the supported plant 50 (such as a seed or seedling). The plug 74 may take the form of a plug of soil, or a plug made from any other growing medium known in the art of hydroponics, such as perlite, gravel, peat, wood fibre, etc.) with the plant (e.g. seed or seedling) being embedded therein. Also, the use of the plugs 74 facilitates the transplanting of the plants, if necessary, as they grow. For example, transplanting is likely to be necessary where the watering apparatus is being used primarily for the purposes of propagating plants. The growing cups 72 are preferably provided with one or more openings or apertures, through which the growth-sustaining liquid may flow into the growing cups during the dunking procedure, and out of the growing cups following the dunking procedure. In the particular embodiment shown where plugs 74 are used to support the supported plants 50, the plugs 74 will also be provided with corresponding openings or apertures. Accordingly, the plants (more specifically, the roots of the plants or the seeds—where the seeds have not yet germinated) may be suitably irrigated. Of course, in the case where the supported plants have already developed leaves, the leaves of the supported plants are not immersed into the growth-sustaining liquid—only the plants' roots are immersed.

It is generally preferred that the growing cups 72 be provided with one or more openings located in the bottom of thereof and located at the top thereof. More preferably, the bottom of the growing cups 72 may be substantially fully open. In such cases, it has been discovered that the surface tension of the water/growth-sustaining liquid is generally sufficient to prevent significant dripping. Having openings located at the bottom of the growing cup 72 generally allows for better drainage of growth-sustaining liquid 22 from the growing cups (to avoid oversaturation or over-flooding), and also allows for liquid transfer to the growing cups 72 without restriction. Further, in some applications, having an opening at the bottom may allow the roots of the growing plants to grow out and extend from the bottom of the growing cup 72; this allows the roots of such growing plants to be “air pruned”, which promotes faster plant growth. Plant growing time is shortened, because the roots are not damaged during transplanting.

While not preferable, it should be understood that it is also possible to have the growing cups be provided with holes/apertures located in the sides of the cups or else only have holes/openings at the top.

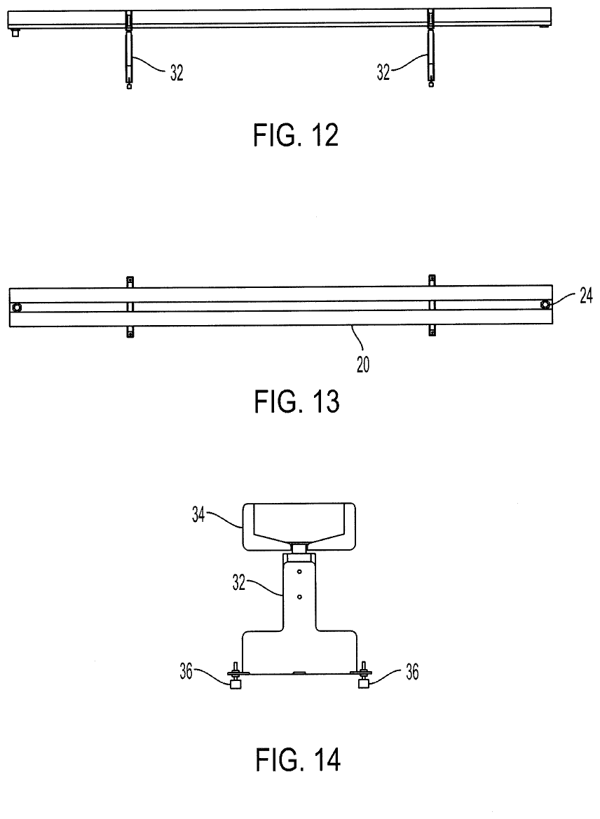

FIG. 11 is a perspective view of another exemplary embodiment of the watering trough. The watering trough 20 is supported by actuators 32. The top 34 of the actuators 32 is affixed to or supports the watering trough 20. The base 36 of the actuators 32 are affixed to the floor/base. As described above, when the actuators 32 are actuated or energized, they will extend, thus elevating the watering trough from a first position to an elevated second position. When the actuators 32 are non-actuated or de-energized, they will collapse back to their original length, thus lowering the watering trough back to the first position. Accordingly, the actuators 32 cause the watering trough 20 to be raised and lowered between the first position and the second position. FIGS. 12, 13 and 14 are respectively, the front side view, the top plan view and an end view of the exemplary embodiment of the watering trough shown in FIG. 11.

Referring to FIG. 15, this is an image of the front view of one side of an exemplary embodiment of the watering apparatus 10, with the growing trays unloaded. The carrier system 40 of the watering apparatus 10 comprises a pair of conveyors 42 (in the form of a chain), only one of which is shown, and a plurality of cradles 44. The conveyor 42 is shown as being engaged with a sprocket wheel 43. The cradles 44 are shown spaced apart on one of the pair of conveyors 42. Each cradle 44 is supported on the conveyor 42 via a pair of cradle hangers 46, each of which is attached to an attachment pin 47. The attachment pins 47 are in turn engaged on one part of the conveyor 42 (or on one link of the chain). As the pair of conveyors 42 are driven, the cradles 44 are conveyed around a path, to and from the watering position (which in the illustrated case is located proximate to the front of the watering apparatus 10).

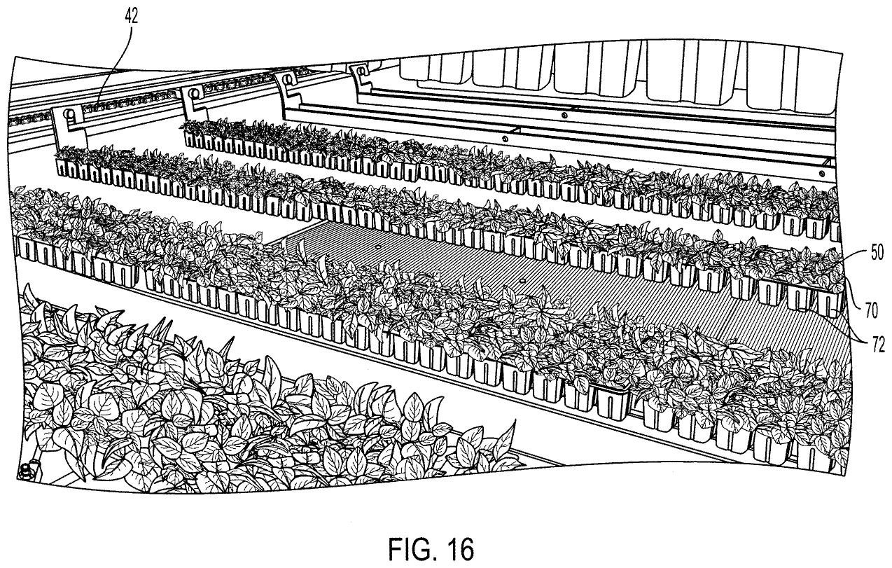

FIG. 16 is an image of an exemplary embodiment of the watering apparatus 10, with the watering trough 20 in a (lowered) first position 54. Each cradle 44 is loaded with a growing tray 70. Each growing tray comprises a plurality of growing cups 72, with each growing cup 72 holding a supported plant 50. When the watering trough 20 is in this lowered first position (which may also be referred to as an “access position”), the cradles 44 and their respective growing trays 70 may be freely conveyed along the path, such that each cradle will successively be conveyed to and past the watering position (generally above the watering trough 20).

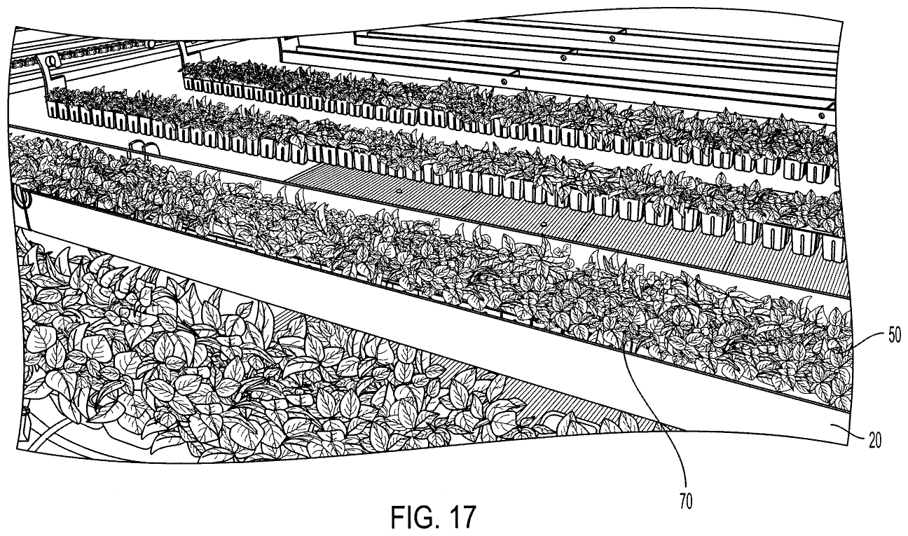

FIG. 17 is an image of the exemplary embodiment of the watering apparatus shown in FIG. 16, with the watering trough 20 in a (elevated) second position 56 (which may also be referred to a “dunking position”). The watering trough 20 has been elevated through operation of the actuators. This causes the particular growing tray 70 that is located at the watering position to be immersed by the watering trough 20, thus exposing the growing tray 70 and the supported plants therein to the growth-sustaining liquid 22 in the watering trough 20. After the plants have been immersed for a suitable time interval, the watering trough is lowered back down, thus causing the growing tray 70 and its supported plants 50 to be removed from the watering trough 20. The cradle 44 which has just been watered can then be conveyed away from the watering position, allowing the next or successive cradle to take its place at the watering position. It is to be understood that in this fashion, the watering apparatus 10 may be utilised to water a batch of growing trays 70 containing a plurality of plants. It is also to be understood that the watering apparatus 10 may be configured so as to have the above-described watering process fully automated.

Also disclosed herein is a plant growing system, in which the apparatus for watering plants as described herein is combined or coupled with a suitable vertical farming plant growing machine. One example of such vertical farming plant growing machines is disclosed in PCT/CA2012/050281 (Publication No. WO2012151691), which involves a plant growing machine wherein a plurality of plant cradles are advanced on an endless conveyor along an undulating growing path having alternating upward and downward portions and having a return portion for looping back thereto; the cradles are removably supported between a pair of parallel endless conveyors, and the cradles are supplied with growth-sustaining liquid and growth-promoting light. Accordingly, a system may be provided in which a vertical farming growing machine provides for plants to be efficiently grown under conducive conditions (and while occupying a relatively small areal footprint), and in which the present watering apparatus may be employed to provide for an efficient and convenient watering or irrigation process for such plants, as and when such watering is needed. The machines may be combined by linking their respective conveyor systems; as cradles of plants are watered on the watering apparatus, they are conveyed along the pair of conveyors and passed along to the growing machine (where the cradles may be more efficiently stacked); the return path of the growing machine conveys cradles (at the other end of the circuit) on to the return path of the watering apparatus in line for watering. Such a system may also be fully automated.

It is contemplated the watering apparatus, system and method disclosed herein provides a number of advantages over conventional practices, particularly those respecting vertical farms where the growing platforms are not stationary.

Firstly, for the present invention, the growth-sustaining liquid generally remains in one position (i.e. where the watering trough is located), typically near the front of the apparatus. There is no need to carry the liquid around in the growing trays or provide for some mechanism to deliver the water to the growing trays as they are conveyed around the plant growing machine. Indeed, with the bottoms of the growing trays/growing cups being substantially open, there is no trough at all where the plants reside. In practice, it has also been discovered that the use of the disclosed watering apparatus (where the watering only occurs at the watering position and the bottoms of the growing trays/growing cups are substantially open) significantly reduces algae growth as compared with growing trays where a volume of the growth-sustaining liquid is actually carried around in the growing trays.

In many conventional plant watering methods, the growth-sustaining liquid may not be evenly administered to each plant; some may get too much, some may not have enough. Further, it is not easy to tell unless the plants are carefully monitored and scrutinized, and in many instances, one may not be able to tell (e.g. that a specific plant is being under watered) until it is too late. Even in circumstances where plants are provided with a set/uniform volume of water, this amount may not be appropriate for each particular plant. In the present invention, however, each plant can uptake growth-sustaining liquid (e.g. water and nutrients) based on its individual requirements; e.g. a younger seedling with a less developed root system may have a different water uptake as compared with a more mature plant with a well-developed root system. Further, each plant will have equal access to the nutrients. One consequence of this is that plants of different sizes, or even plants that are at different stages of growth (i.e. a seed, a seedling and a fully grown plant) can be watered and grown on the same watering apparatus without compromising growth. By the same reckoning, it can even be possible to grow plants of altogether different types together on the same watering apparatus (or even in the same growing tray).

In many conventional watering systems when these are used with very young seedlings, there is a risk that the fragile roots systems of such seedlings may be damaged or disturbed. The watering system of the present invention, particularly where the bottoms of the growing trays/growing cups are open and hence provide better drainage, have been found to be relatively gentle and suitable for use with very young or fragile seedlings.

The system of conveying the cradles around a path until they reach a watering position, and then flooding each cradle using the watering trough, allows for a simple carrier system. An alternative of providing for a conveyor system which dunks each cradle into a stationary watering trough, requires a more complex conveyor system (from an engineering perspective).

1. An apparatus for watering plants comprising:
a watering trough, for receiving and holding a growth-sustaining liquid therein;
an actuator means configured to actuate the watering trough between a first position and a second position; and
a carrier system comprising a pair of conveyors and a plurality of cradles, the plurality of cradles supported by the pair of conveyors and spaced apart therealong, each one of the plurality of cradles supporting one or more supported plants therein;
wherein the pair of conveyors is configured to convey the plurality of cradles along a path, thereby transporting each one of the plurality of cradles to and from a watering position,
wherein when said one of the plurality of cradles is at the watering position and the watering trough is in the second position, said one or more supported plants is at least partially immersed in the growth-sustaining liquid in the watering trough so as to permit uptake of the growth-sustaining liquid by the one or more supported plants, and when said one of the plurality of cradles is at the watering position and the watering trough is in the first position, said one or more supported plants is removed from the growth-sustaining liquid in the watering trough.

2. An apparatus for watering plants comprising:
a watering trough, for receiving and holding a growth-sustaining liquid therein;
an actuator configured to actuate the watering trough between a first position and a second position; and
a carrier system comprising a pair of conveyors and a plurality of cradles, the plurality of cradles supported by the pair of conveyors and spaced apart therealong, each cradle supporting a growing tray, the growing tray adapted to receive and support one or more supported plants therein;
wherein the pair of conveyors is configured to convey the plurality of cradles along a path, thereby transporting each one of the plurality of cradles to and from a watering position,
wherein when said one of the plurality of cradles is at the watering position and the watering trough is in the second position, said one or more supported plants is at least partially immersed in the growth-sustaining liquid in the watering trough so as to permit uptake of the growth-sustaining liquid by the one or more supported plants, and when said one of the plurality of cradles is at the watering position and the watering trough is in the first position, said one or more supported plants is removed from the growth-sustaining liquid in the watering trough.

3. An apparatus for watering plants comprising:
a watering trough, for receiving and holding a growth-sustaining liquid therein;
an actuator configured to actuate the watering trough between an access position and a dunking position; and
a carrier system comprising a pair of conveyors and a plurality of cradles, the plurality of cradles supported by the pair of conveyors and spaced apart therealong, each cradle supporting a growing tray, the growing tray adapted to receive and support one or more supported plants therein;
wherein the pair of conveyors is configured to convey the plurality of cradles along a path, thereby transporting each one of the plurality of cradles to and from a watering position,
wherein when said one of the plurality of cradles is at the watering position and the watering trough is in the dunking position, said one or more supported plants is at least partially immersed in the growth-sustaining liquid in the watering trough so as to permit uptake of the growth-sustaining liquid by the one or more supported plants,
and when the watering trough is in the access position, the said one of the plurality of cradles may be conveyed by the conveyor away from the watering position and a successive one of the plurality of cradles may be conveyed by the conveyor to the watering position.

4. The apparatus for watering plants of claim 1, wherein the pair of conveyors are endless conveyors, and the path is a continuous loop.

5. The apparatus for watering plants of claim 1, wherein each growing tray is provided with a plurality of growing cups for supporting the supported plants.

6. The apparatus for watering plants of claim 5, wherein the growing cups are provided with an opening disposed in the bottom of said growing cups.

7. The apparatus for watering plants of claim 1, wherein the supported plants are seeds or seedlings.

8. The apparatus for watering plants of claim 1, wherein the second position is substantially vertically above the first position.

9. The apparatus for watering plants of claim 1, wherein when each of the plurality of cradles is in the watering position, said cradle is disposed substantially above the watering trough.

10. The apparatus for watering plants of claim 1, wherein the carrier system is additionally provided with a motor for driving the conveyor.

11. The apparatus for watering plants of claim 1, wherein the carrier system is manually driven.

12. The apparatus for watering plants of claim 1, wherein the actuator means comprises one or more actuators.

13. The apparatus for watering plants of claim 12, wherein the one or more actuators are pneumatically-driven air return cylinders.

14. The apparatus for watering plants of claim 1, wherein the plants are of different types.

15. The apparatus for watering plants of claim 1, wherein the plants are at different stages of growth.

16. A method for watering plants comprising the steps of:
(i) providing a watering apparatus comprising:
a watering trough, for receiving and holding a growth-sustaining liquid therein;
an actuator configured to actuate the watering trough between a first position and a second position; and
a carrier system comprising a pair of conveyors and a plurality of cradles, the plurality of cradles supported by the pair of conveyors and spaced apart therealong, each one of the plurality of cradles supporting one or more supported plants therein;
wherein the pair of conveyors is configured to convey the plurality of cradles along a path, thereby transporting each one of the plurality of cradles to and from a watering position;
(ii) operating the pair of conveyors to convey a first one of the plurality of cradles to the watering position;
(iii) filling the watering trough with growth-sustaining liquid;
(iv) activating the actuator to actuate the watering trough from the first position to the second position, thereby immersing the supported plants in the growth-sustaining liquid;
(v) deactivating the actuators to return the watering trough from the second position to the first position;
(vi) operating the pair of conveyors to convey the cradle away from the watering position and to convey a successive cradle to the watering position; and
(vii) repeating from step (iii) for successive cradles.
